(19) United States
(12) Patent Application Publication
(10) Pub. No.: US 2026/0228818 A1
(43) Pub. Date: Aug. 6, 2026

(54) BEI BANKING KERNEL AND BEIFR2 MULTI-LEDGER FINANCIAL OPERATING SYSTEM

(71) Applicant: FURONG BEI, SAN GABRIEL, CA (US)

(72) Inventor: FURONG BEI, SAN GABRIEL, CA (US)

(21) Appl. No.: 19/419,105

(22) Filed: Dec. 15, 2025

Related U.S. Application Data
(63) Continuation-in-part of application No. 19/056,745, filed on Feb. 19, 2025.
(63) Continuation-in-part of application No. 19/060,663, filed on Feb. 22, 2025.
(63) Continuation-in-part of application No. 19/067,732, filed on Feb. 28, 2025.
(63) Continuation-in-part of application No. 19/072,075, filed on Mar. 6, 2025.
(63) Continuation-in-part of application No. 19/073,574, filed on Mar. 7, 2025, now abandoned.
(63) Continuation-in-part of application No. 19/074,326, filed on Mar. 8, 2025, now abandoned.
(63) Continuation-in-part of application No. 19/076,910, filed on Mar. 11, 2025.
(63) Continuation-in-part of application No. 19/084,806, filed on Mar. 20, 2025.
(63) Continuation-in-part of application No. 19/086,144, filed on Mar. 21, 2025, now abandoned.
(63) Continuation-in-part of application No. 19/094,730, filed on Mar. 28, 2025.
(63) Continuation-in-part of application No. 19/059,110, filed on Feb. 20, 2025, now abandoned.

(51) Int. Cl. G06Q 40/02; G06Q 20/40

(52) U.S. Cl. CPC G06Q 40/02; G06Q 20/407

(57) ABSTRACT

A computer-implemented banking kernel provides a unified identity, product, and rollback layer for banking, markets, and payments. One or more processors maintain machine-readable Behavioral Economics Identity (BEI) profiles for entities, a global product registry in which each financial product has an encoded product type, complexity class, risk class, jurisdictional parameters, and a reference to a BEI FR2 (BEIFR2) policy profile, and a tri-header contract and receipt store. Application portals submit admission requests and BEIFR2 event notifications to the kernel via programmatic interfaces. For admission requests, the kernel evaluates BEI profile metrics against product parameters to generate suitability-based admission decisions and disclosures. For BEIFR2 events such as mis-selling, hardship, error, or fraud, the kernel computes a bounded rollback plan and coordinates atomic, idempotent updates across heterogeneous ledgers, including core-banking, payment, and market ledgers, while updating corresponding tri-header receipts for supervisory visibility, consistency, and auditability.

### CROSS-REFERENCE TO RELATED APPLICATIONS

This application claims the benefit of U.S. Provisional Application No. 63/769,143, filed Mar. 9, 2025, under 35 U.S.C. § 119(e).

This application is also a Continuation-in-Part (CIP) of the following U.S. patent applications, each commonly owned. The applications listed in Section A are relied upon for priority under 35 U.S.C. § 120. Corresponding continuity data will be provided in the Application Data Sheet (ADS). The applications listed in Section B are related applications that are not relied upon for priority but are incorporated by reference as noted below.

### A. Priority Parents (Relied Upon for Priority)

U.S. application Ser. No. 19/056,745, filed Feb. 19, 2025.
U.S. application Ser. No. 19/060,663, filed Feb. 22, 2025.
U.S. application Ser. No. 19/067,732, filed Feb. 28, 2025.
U.S. application Ser. No. 19/072,075, filed Mar. 6, 2025.
U.S. application Ser. No. 19/073,574, filed Mar. 7, 2025.
U.S. application Ser. No. 19/074,326, filed Mar. 8, 2025.
U.S. application Ser. No. 19/076,910, filed Mar. 11, 2025.
U.S. application Ser. No. 19/084,806, filed Mar. 20, 2025.
U.S. application Ser. No. 19/086,144, filed Mar. 21, 2025.
U.S. application Ser. No. 19/094,730, filed Mar. 28, 2025.

### B. Related Applications Incorporated by Reference (Not Relied Upon for Priority)

U.S. application Ser. No. 19/171,201, filed Apr. 5, 2025.
U.S. application Ser. No. 19/374,710, filed Oct. 30, 2025.
U.S. application Ser. No. 19/406,982, filed Dec. 3, 2025.
U.S. application Ser. No. 19/403,793, filed Dec. 2, 2025.
U.S. application Ser. No. 19/059,110, filed Feb. 20, 2025.
U.S. Publication No. 2025/0209466 A1, published Jun. 26, 2025.
U.S. Publication No. 2025/0259241 A1, published Aug. 14, 2025.

To the extent not inconsistent with the present disclosure, the disclosures of the above-listed applications and publications are incorporated by reference herein in their entirety. Applicants will ensure that the ADS reflects the foregoing continuity relationships and that these documents are also identified on any applicable Information Disclosure Statement (PTO/SB/08a).

### DESCRIPTION

### Technical Field

The present disclosure relates generally to computer-implemented financial systems, and more particularly to a BEI banking kernel and BEI FR2 (BEIFR2) multi-ledger financial operating system that coordinates behavior-based admission decisions, bounded rollback of financial transactions, and supervisory transparency across banking, market, and payment infrastructures.

### Background

Conventional financial infrastructures are typically implemented as a collection of separate systems operated by banks, card networks, payment processors, and exchanges. Product admission checks, refund and chargeback processing, and dispute resolution are often implemented as institution-specific applications that operate against isolated ledgers. There is no unified kernel that coordinates behavior-based suitability checks, standardized bounded rollback policies, and multi-ledger updates across banking, market, and remittance subsystems.

Known identity and know-your-customer (KYC) systems generally store static identifiers and limited risk ratings that are not directly referenced by product-admission logic and are not linked to standardized rollback policies. Known refund and chargeback mechanisms are typically limited to a single payment network or ledger and do not coordinate reversals across core-banking, securities, and remittance ledgers. These architectures can result in inconsistent partial reversals, extensive manual reconciliation, and fragmented consumer-protection outcomes.

There is a need for a computer-implemented banking kernel that unifies identity, product, rollback, and supervisory layers, so that behavior-based admission decisions and bounded rollback plans can be computed and executed consistently across heterogeneous financial systems, while providing synchronized human-readable, machine-execution, and supervisory records.

### SUMMARY

The disclosed BEI banking kernel provides a unified identity, product, and rollback layer for banking, markets, and payments. The kernel maintains machine-readable Behavioral Economics Identity (BEI) profiles for entities, a global product registry in which each financial product has an encoded product type, complexity class, risk class, jurisdictional parameters, and a reference to a BEI FR2 (BEIFR2) policy profile, and a tri-header contract and receipt store. Application portals submit admission requests and BEIFR2 event notifications to the kernel via programmatic interfaces. For admission requests, the kernel evaluates BEI profile metrics against product parameters to generate suitability-based admission decisions and disclosures. For BEIFR2 events such as mis-selling, hardship, error, or fraud, the kernel computes a bounded rollback plan and coordinates atomic, idempotent updates across heterogeneous ledgers, including core-banking, payment, and market ledgers, while updating corresponding tri-header receipts for supervisory visibility and auditability.

The BEI banking kernel introduces a unified identity and behavior profile store maintained as machine-readable BEI profiles, a global product registry with BEIFR2 policy references, a BEIFR2 engine that coordinates multi-ledger rollback plans, and a tri-header contract and receipt store that provides synchronized views of each transaction. These data structures and processes are implemented by processors and non-transitory computer-readable media and provide concrete improvements in how computer systems process, reconcile, and supervise financial transactions.

From a computing perspective, the disclosed BEI banking kernel improves the functioning of financial computer systems themselves. By centralizing admission, rollback, and supervisory logic in a single kernel, and by enforcing atomic and idempotent execution of BEIFR2 rollback plans across heterogeneous ledgers, the system reduces inconsistent partial reversals, avoids repeated processing of duplicate rollback requests, and eliminates many manual reconciliation steps that would otherwise be required in fragmented architectures.

In some embodiments, the BEI banking kernel further includes a namespace service that maintains mappings between entities, products, and domain-name namespaces including identity domains such as BEI.app and BEIDID.com, kernel domains such as BEIKernel.com and BankingKernel.com, registry domains such as BEIRegistry.com and ParcelRegistry.com, banking domains such as ATMS.com, ATMSBanking.com, BEIBanking.com, and SOVBanking.com, market domains such as BEIGX.com, BEISX.com, BEICX.com, and BEIMX.com, currency domains such as BEIUSD.com, BEICNY.com, and BEIEUR.com, and ecosystem domains such as BEIECO.com, BEIECO.org, BankEco.org, and BankEco.app. Application portals such as BXS.app, FB2.app, FB.app, and BNKS.app interact with the BEI banking kernel and provide entry points for customers, institutions, and supervisory entities.

The BEI banking kernel architecture is modular, with the BEI identity store, product registry, BEIFR2 policy store, and tri-header store capable of deployment as independent microservices. This modularity allows financial institutions and technology providers to license or implement specific components to augment existing core-banking or payment systems, creating multiple commercialization avenues for the core technology and enabling gradual migration from legacy infrastructures.

### Definitions

As used herein, the term “Behavioral Economics Identity” or “BEI” refers to a machine-readable representation of the behavior, capacity, and risk characteristics of an individual or organization, including one or more BEI scores and associated attributes that can be updated over time based on observed events.

As used herein, the term “BEI FR2” or “BEIFR2” refers to a BEI Fair and Reversible Rail implemented under the BEI framework, for example via BEIFR2.com and BEIFR2.org domains. A BEIFR2 policy profile encodes machine-readable conditions, budgets, caps, eligibility criteria, and allocation formulas for computing bounded rollback or remediation plans in response to mis-selling, error, fraud, hardship, or other declared events.

As used herein, the term “tri-header contract” or “tri-header receipt” refers to a data structure comprising at least a human-readable head, a machine-execution head, and a supervisory head that share a common transaction identifier and collectively describe a financial transaction and any associated BEIFR2 events.

As used herein, the term “ledger” refers to any data structure used to record financial positions or movements, including without limitation core-banking ledgers, card or payment network ledgers, securities or derivatives ledgers, Central Bank Digital Currency (CBDC) or other tokenized settlement ledgers, and supervisory or metrics ledgers, and can be implemented using centralized or distributed technologies.

### BRIEF DESCRIPTION OF THE DRAWINGS

FIG. 1 is a block diagram of an example BEI banking kernel and its interfaces with banking, market, payment, and supervisory subsystems.

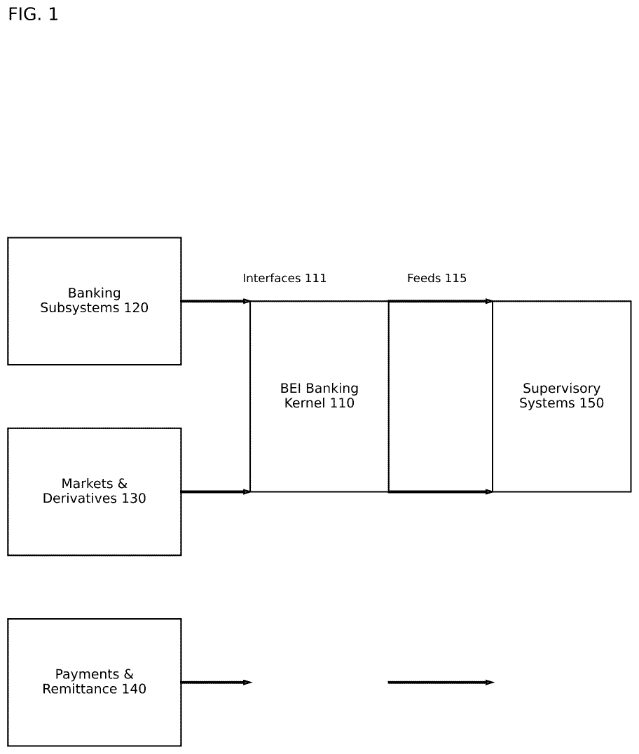

FIG. 2 is a block diagram illustrating example BEI profiles, a BEIDID record, a product registry, BEIFR2 policy profiles, and tri-header contract and receipt records.

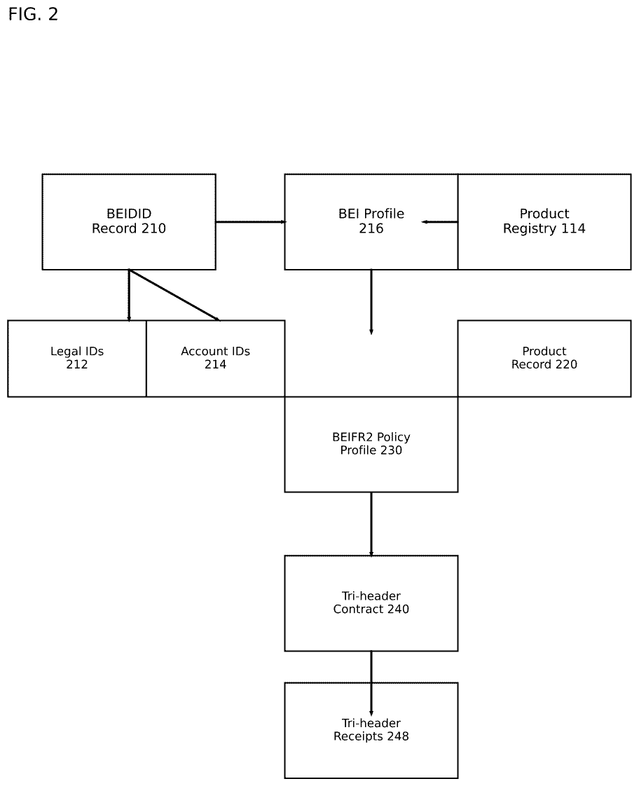

FIG. 3 is a flowchart of an example admission process executed by the BEI banking kernel.

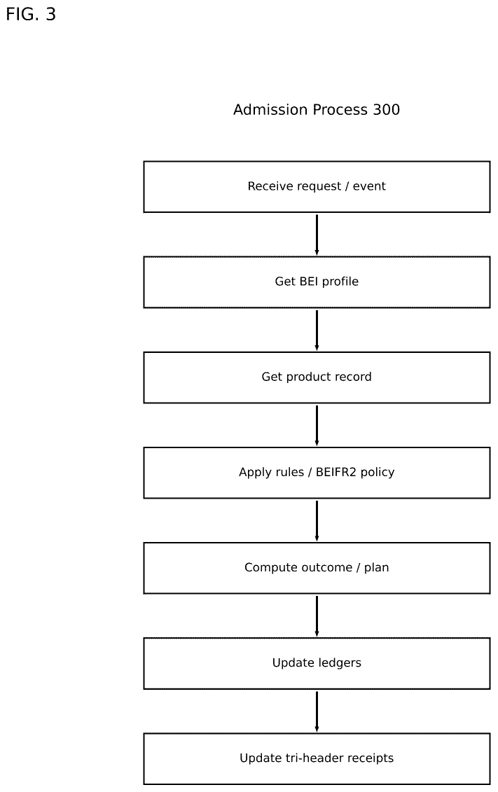

FIG. 4 is a flowchart of an example BEIFR2 mis-selling flow.

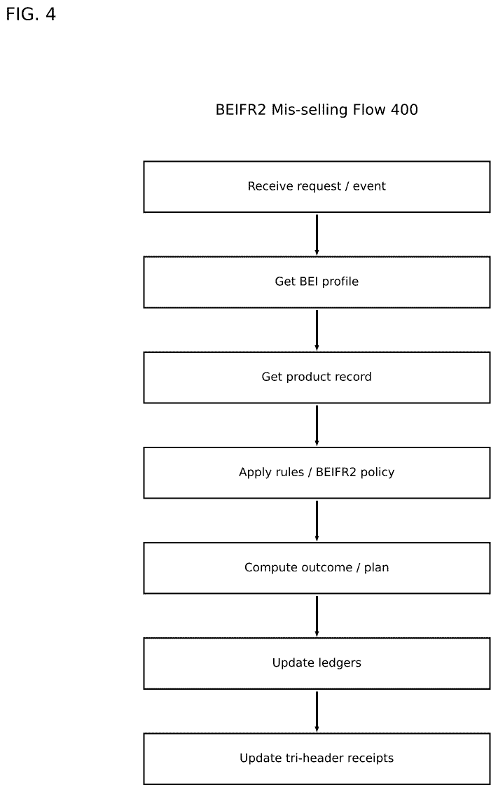

FIG. 5 is a flowchart of an example BEIFR2 hardship flow.

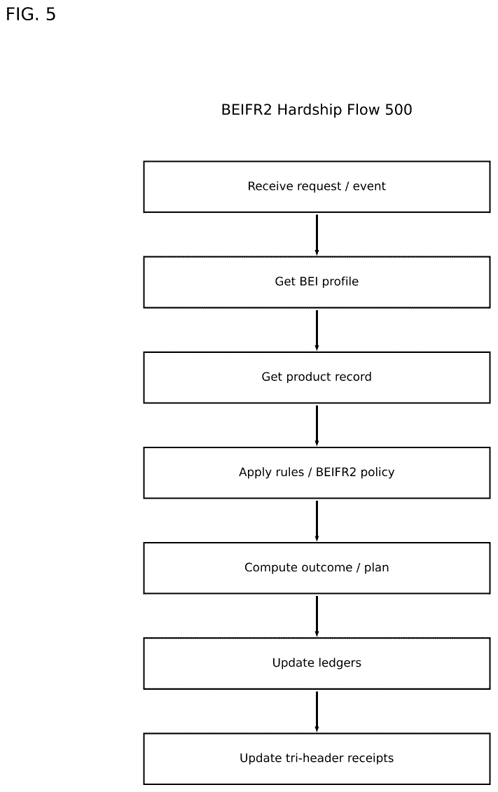

FIG. 6 is a flowchart of an example BEIFR2 error or fraud flow.

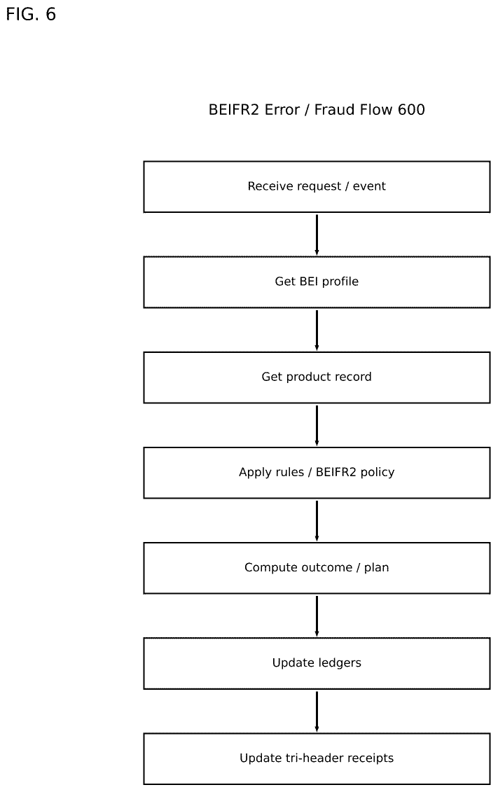

FIG. 7 is a schematic diagram of an example multi-domain namespace associated with BEI identity, kernel, registry, banking, market, currency, and ecosystem domains.

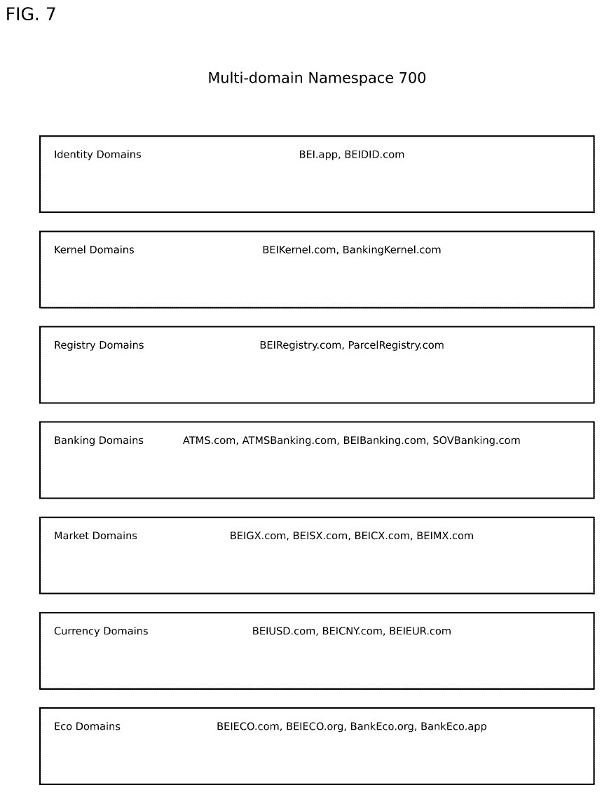

FIG. 8 is a block diagram illustrating example application portals, including banking execution, BEIFR2, financial banking, and multi-bank aggregation portals, interfacing with the BEI banking kernel and underlying subsystems.

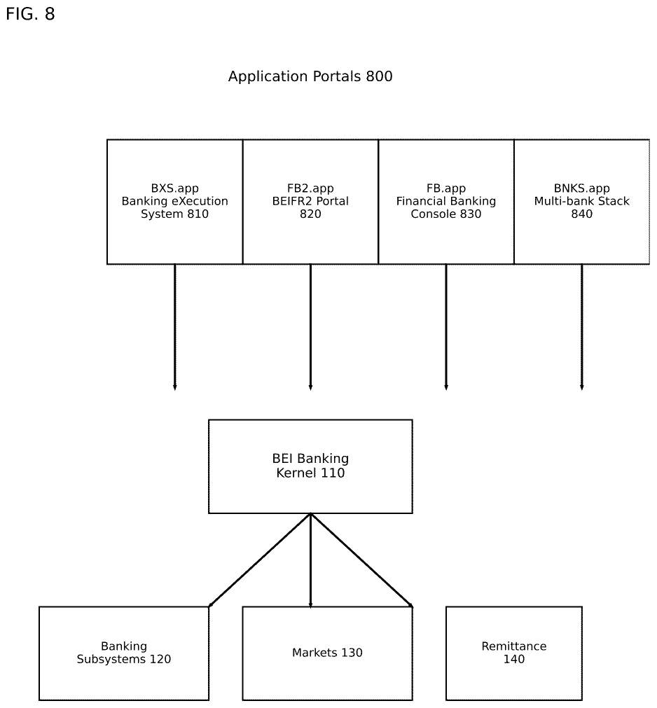

### DETAILED DESCRIPTION

In some embodiments, a BEI banking kernel is implemented as a set of one or more servers or virtualized services interconnected over one or more networks. The BEI banking kernel exposes programmatic interfaces to a plurality of banking subsystems, market subsystems, and payment or remittance subsystems, as well as to supervisory systems. The banking subsystems can include core-banking platforms, lending and deposit systems, and digital banking front ends. The market subsystems can include exchange, derivatives, and trading platforms. The payment or remittance subsystems can include card networks, instant payment networks, and cross-border remittance platforms.

In contrast to conventional architectures in which each banking or payment platform implements its own admission rules and refund logic against separate ledgers, without a shared coordination layer, the BEI banking kernel operates as a unifying operating layer for multiple ledgers. The kernel's use of a common transaction identifier, a tri-header record structure, and idempotency tokens for BEIFR2 events enables the underlying computing infrastructure to maintain strong consistency guarantees even when the participating ledgers are implemented on different technologies and controlled by different institutions.

The BEI banking kernel is designed for compatibility with emerging financial technologies, including tokenized assets and Central Bank Digital Currencies (CBDCs). The BEIFR2 mechanism provides a bounded reversibility and remediation layer for digital currencies in which settlement finality is typically immediate and irreversible. By treating CBDC ledgers and other tokenized settlement ledgers as supported ledgers in the multi-ledger architecture, the kernel can apply identity-based admission decisions and atomic, idempotent rollback plans to transactions involving digital currencies, thereby enhancing fraud prevention, consumer protection, and supervisory oversight for CBDC and other digital-asset flows.

The BEIFR2 policy store and associated policy engine further support advanced governance models, including deployment within regulatory sandbox environments. BEIFR2 policy profiles can be versioned and configured with mandatory supervisory sign-offs, enabling regulators or designated institutions to test modified consumer-protection rules, such as alternative hardship schedules or mis-selling formulas, in a controlled setting. The supervisory head of the tri-header receipts, which includes normalized BEIFR2 risk tags and metrics, provides a machine-readable, real-time auditing surface for monitoring the effect of such sandbox policies and for promoting transparent, data-driven regulatory oversight.

The BEI banking kernel maintains an identity store comprising BEI profiles for individuals and organizations. Each BEI profile can include behavior-based metrics such as repayment regularity, incident history with prior BEIFR2 events, literacy indicators, and product-complexity tolerance indicators. A BEIDID record can link one or more legal identifiers, account identifiers, and BEI profiles for an entity. In some embodiments, BEI profiles are updated over time using machine-learning models that consume historical transaction and BEIFR2 event data.

The BEI banking kernel further maintains a product registry storing machine-readable product records for financial products including, without limitation, banking products, investment products, derivatives, and remittance products. Each product record includes a product type, a complexity class, a risk class, a jurisdiction code, and a reference to at least one BEIFR2 policy profile. The product record can additionally specify permitted BEI segments, disclosure templates, and supervisory classifications.

The BEIFR2 policy store maintained by the BEI banking kernel stores BEIFR2 policy profiles. Each BEIFR2 policy profile encodes eligibility criteria for BEIFR2 events, rollback budgets and caps, loss-allocation formulas, and hardship schedules. Different BEIFR2 policy profiles can be associated with different product types, jurisdictions, or supervisory regimes.

For each admitted transaction, the BEI banking kernel generates or updates a tri-header contract and later a tri-header receipt. The human-readable head contains language suitable for customers, derived from standard disclosure templates associated with the product record. The machine-execution head contains structured data consumable by banking, market, and payment subsystems, and may include machine-readable encodings of BEI and BEIFR2 parameters. The supervisory head contains normalized fields for regulators or supervisory entities, including identifiers for entities, products, and any associated BEIFR2 events.

Each tri-header contract and subsequent receipt is structured to ensure synchronization of information across the human-readable head, the machine-execution head, and the supervisory head. The human-readable head comprises natural language summaries, personalized risk warnings derived from the entity's BEI profile, and a plain-language summary of BEIFR2 rights and conditions for the transaction. The machine-execution head comprises at least a contract state machine code, a unique idempotency token configured to enforce the atomic, idempotent multi-ledger update by uniquely identifying a corresponding BEIFR2 event, and one or more ledger commit references identifying original postings across heterogeneous ledgers. The supervisory head comprises normalized product classification codes, at least one BEIFR2 risk tag derived from comparing the BEI profile to the product's complexity class and risk class, and loss allocation percentages or rollback budget limits associated with the referenced BEIFR2 policy profile. The BEI banking kernel enforces that updates to critical fields, including principal amounts and BEIFR2 budgets, are synchronized across all heads of the tri-header record.

When an application portal, such as a portal associated with a BXS.app, FB.app, FB2.app, BNKS.app, BEI.app, or ATMS.com domain, submits a transaction admission request, the BEI banking kernel identifies the requesting entity, retrieves the corresponding BEI profile and one or more candidate product records, evaluates the BEI profile metrics against the product complexity class, risk class, jurisdictional parameters, and permitted BEI segments, and generates an admission decision. The admission decision can take the form of a machine-readable decision code, and the BEI banking kernel can also select specific disclosure templates for inclusion in the human-readable head of a tri-header contract.

When a BEIFR2 event notification is received from a banking, market, or payment subsystem, the BEI banking kernel retrieves the relevant BEI profile, product record, BEIFR2 policy profile, and tri-header transaction record. The BEIFR2 engine computes a bounded rollback plan that specifies a set of correlated adjustments to be applied to a plurality of heterogeneous ledgers, including at least a core-banking ledger, a payment ledger, and optionally a market ledger and a supervisory metrics ledger. The rollback plan can specify amounts to be refunded, fees to be waived, schedules for rescheduled payments, or loss allocations between institutions.

The BEIFR2 engine executes the rollback plan via ledger adapters using atomic, idempotent transaction semantics. In some embodiments, one or more ledger adapters implement a two-phase commit protocol or a consensus protocol such that either all ledger updates succeed or all ledger updates are rolled back. For each BEIFR2 event, the BEI banking kernel generates a unique BEIFR2 event identifier, records the event identifier in the tri-header receipt, and enforces idempotent execution by discarding any subsequent rollback requests that reference the same BEIFR2 event identifier after successful completion of the rollback plan.

The BEI banking kernel can record metrics values associated with BEIFR2 events, including at least a time-to-resolution value, a percentage-of-amount-rolled-back value, and a hardship impact score, and can store these metrics in a supervisory metrics ledger. Supervisory systems can query the BEI banking kernel to retrieve BEIFR2 event information and associated tri-header receipts to monitor systemic and consumer-protection risk in near real time.

In some embodiments, a namespace service maintains mappings between entities, products, and domain-name namespaces including identity domains such as BEI.app and BEIDID.com, kernel domains such as BEIKernel.com and BankingKernel.com, registry domains such as BEIRegistry.com and ParcelRegistry.com, banking domains such as ATMS.com, ATMSBanking.com, BEIBanking.com, and SOVBanking.com, market domains such as BEIGX.com, BEISX.com, BEICX.com, and BEIMX.com, currency domains such as BEIUSD.com, BEICNY.com, and BEIEUR.com, and ecosystem domains such as BEIECO.com, BEIECO.org, BankEco.org, and BankEco.app. Application portals such as BXS.app, FB2.app, FB.app, and BNKS.app provide user interfaces or APIs for customers, institutions, and supervisors to interact with the BEI banking kernel via these namespaces.

The BEI banking kernel, BEI profiles, product registry, BEIFR2 policy store, tri-header receipt store, and namespace service can be implemented using any suitable combination of databases, distributed ledger technologies, and application servers. In some embodiments, one or more subsystems use blockchain or distributed ledger platforms to record tri-header receipts or BEIFR2 events, while other subsystems use relational or NoSQL databases. The BEI banking kernel can be deployed as a microservice architecture and can expose REST, gRPC, or message-queue interfaces to external subsystems. Alternative embodiments and variations will be apparent to persons skilled in the art in view of this disclosure.

What is claimed is:

1. A computer-implemented banking kernel system for coordinating behavior-based admission decisions and bounded rollback of financial transactions across heterogeneous financial ledgers, the system comprising: one or more processors; and one or more non-transitory computer-readable media storing instructions which, when executed by the one or more processors, cause the system to: maintain an identity store comprising a plurality of Behavioral Economics Identity (BEI) profiles for respective entities, each BEI profile including behavior-based metrics and capacity indicators for a corresponding entity; maintain a product registry comprising a plurality of machine-readable product records, each product record defining a financial product and including at least a product type, a complexity class, a risk class, and a reference to a BEI FR2 (BEIFR2) policy profile; maintain a BEIFR2 policy store comprising a plurality of BEIFR2 policy profiles, each BEIFR2 policy profile encoding machine-readable rules for bounded rollback of transactions including at least one eligibility condition, a rollback budget, and an allocation formula; maintain a tri-header receipt store comprising a plurality of tri-header transaction records, each tri-header transaction record including a human-readable head, a machine-execution head, and a supervisory head that reference a common transaction identifier; expose, to a plurality of banking subsystems, market subsystems, and payment or remittance subsystems, a set of kernel interfaces configured to receive transaction admission requests and BEIFR2 event notifications; for a transaction admission request received from a requesting subsystem, identify a requesting entity, retrieve a corresponding BEI profile and a selected product record, evaluate at least the complexity class and the risk class of the product record against one or more metrics in the BEI profile, and generate an admission decision and associated disclosures for the requesting subsystem; and for a BEIFR2 event notification associated with at least one prior transaction, retrieve a corresponding BEIFR2 policy profile and one or more tri-header transaction records, compute a rollback plan that specifies coordinated adjustments to a plurality of heterogeneous ledgers maintained by at least two of the banking subsystems, the market subsystems, and the payment or remittance subsystems, and coordinate execution of the rollback plan as an atomic, idempotent multi-ledger update using standardized ledger adapters, wherein the atomic, idempotent multi-ledger update reduces reconciliation passes, prevents duplicate or conflicting rollback entries under retry conditions, and improves consistency of stored ledger states across the heterogeneous ledgers relative to systems in which refund or chargeback logic is implemented independently by separate subsystems.

2. The system of claim 1, wherein each BEI profile comprises at least a literacy indicator, a product-complexity tolerance indicator, and a supervisory suitability code used by the admission decision to constrain access to financial products above a corresponding complexity class.

3. The system of claim 1, wherein the instructions further cause the system to update the BEI profiles over time using at least one machine-learning model trained on historical BEIFR2 events, such that entities associated with repeated mis-selling or delinquency events receive adjusted risk or behavior scores.

4. The system of claim 1, wherein each product record in the product registry further comprises a jurisdiction code, a list of permitted BEI segments, and a reference to at least one standard disclosure template used in a human-readable head of a tri-header contract.

5. The system of claim 1, wherein coordinating execution of the rollback plan comprises submitting rollback sub-transactions to respective ledger adapters implementing at least one of a two-phase commit protocol or a consensus protocol, to ensure that either all ledger updates succeed or all ledger updates are rolled back.

6. The system of claim 1, wherein each tri-header transaction record comprises: a human-readable head including a BEIFR2 rights summary for a corresponding transaction; a machine-execution head including a contract state machine code, a unique idempotency token configured to enforce the atomic, idempotent multi-ledger update by uniquely identifying a corresponding BEIFR2 event, and one or more ledger commit references identifying original postings on the heterogeneous ledgers; and a supervisory head including normalized product classification codes and at least one BEIFR2 risk tag derived from comparing the entity's BEI profile to the product's complexity class and risk class, and wherein the tri-header transaction record is digitally signed using at least one cryptographic signature associated with the entity and at least one cryptographic signature associated with a supervising institution.

7. The system of claim 1, wherein the admission decision comprises generating a machine-readable decision code indicating one of: automatic approval, conditional approval with additional disclosures, referral to a human reviewer, or denial, and storing the decision code in association with the transaction identifier.

8. The system of claim 1, further comprising a namespace service configured to maintain mappings between entities, products, and a plurality of domain-name namespaces including an identity namespace, a banking namespace, and a market namespace, the domain-name namespaces comprising a plurality of branded domains corresponding to respective subsystems.

9. The system of claim 1, wherein the kernel interfaces comprise application programming interfaces, APIs, consumable by a plurality of application portals including at least a banking execution portal, a BEIFR2 portal, a financial banking console, and a multi-bank aggregation portal.

10. The system of claim 1, wherein the application portals include non-limiting examples associated with one or more domains selected from the group consisting of BEI.app, ATMS.com, BEIBanking.com, BEIGX.com, BEICX.com, BEISX.com, BEIUSD.com, BEICNY.com, BEIEUR.com, BEIECO.com, BEIECO.org, BankEco.org, BankEco.app, BXS.app, FB2.app, FB.app, and BNKS.app.

11. A computer-implemented method executed by a banking kernel system, the method comprising:
receiving, from a banking subsystem, a BEIFR2 event notification associated with a prior financial transaction, the BEIFR2 event notification including at least a transaction identifier and an event type;
retrieving, from an identity store, a BEI profile associated with an entity for the prior financial transaction;
retrieving, from a product registry, a product record associated with the prior financial transaction, the product record including a reference to a BEIFR2 policy profile;
retrieving the BEIFR2 policy profile from a BEIFR2 policy store;
computing, based on the BEIFR2 policy profile and at least one metric from the BEI profile, a rollback plan including at least one adjustment to a plurality of ledgers maintained by at least two different financial subsystems; and
causing coordinated execution of the rollback plan to update the plurality of ledgers and to store an updated tri-header receipt for the prior financial transaction.

12. The method of claim 11, wherein the event type indicates mis-selling, and computing the rollback plan comprises computing at least one partial refund amount and at least one fee waiver while preserving a minimum principal balance defined in the BEIFR2 policy profile.

13. The method of claim 11, wherein the event type indicates hardship, and computing the rollback plan comprises rescheduling future payments according to a hardship schedule defined in the BEIFR2 policy profile.

14. The method of claim 11, wherein the event type indicates error or fraud, and computing the rollback plan comprises reversing at least one posting and reallocating loss according to a loss-allocation formula defined in the BEIFR2 policy profile.

15. The method of claim 11, further comprising identifying a prior tri-header contract record for the prior financial transaction and recording, in at least one head of the updated tri-header receipt, a reference to the BEIFR2 event and to the rollback plan.

16. The method of claim 11, further comprising recording at least one metrics value associated with the BEIFR2 event, including at least one of: a time-to-resolution value, a percentage-of-amount-rolled-back value, or a hardship impact score, and storing the metrics value in a supervisory metrics ledger.

17. The method of claim 11, wherein causing coordinated execution of the rollback plan comprises generating a unique BEIFR2 event identifier for the BEIFR2 event and enforcing idempotent execution by discarding any subsequent rollback requests that reference the same BEIFR2 event identifier after successful completion of the rollback plan.

18. A non-transitory computer-readable medium storing instructions which, when executed by one or more processors of a banking kernel system, cause the system to perform the method of claim 11.

19. The non-transitory computer-readable medium of claim 18, wherein the instructions further cause the system to train or update at least one machine-learning model using historical BEIFR2 events and to update BEI profiles based on outputs of the machine-learning model.

20. The non-transitory computer-readable medium of claim 18, wherein the instructions further cause the system to expose programmatic interfaces for receiving BEIFR2 event notifications from external portals and for providing real-time supervisory views of BEIFR2 events and associated tri-header receipts.
